(19) United States
(12) Patent Application Publication
(10) Pub. No.: US 2014/0325840 A1
(43) Pub. Date: Nov. 6, 2014

(54) METHOD OF MANUFACTURING CYLINDER LINE FOR ENGINE

(71) Applicant: Caterpillar Inc., Peoria, IL (US)

(72) Inventor: Bradley L. Morgan, Chillicothe, IL (US)

(21) Appl. No.: 14/336,303

(22) Filed: Jul. 21, 2014

(51) Int. Cl. F02F 1/00; B23P 15/00

(52) U.S. Cl. CPC F02F 1/004; B23P 15/00; F02F 2200/00
USPC 29/888.061

(57) ABSTRACT

A method of manufacturing a cylinder liner for an engine is provided. The method includes forming a semi-finished cylinder liner having an inner surface and an outer surface; rough machining the inner surface and the outer surface of the semi-finished cylinder liner; precision machining the inner surface and outer surface of the rough machined cylinder liner; and machining the inner surface of the precision machined cylinder liner by a roll skiving operation and a roll burnishing operation.

### TECHNICAL FIELD

The present disclosure relates to a method of manufacturing a cylinder liner for an engine.

### BACKGROUND

Conventional methods of manufacturing cast or extruded cylinder liners used in internal combustion engines involves a complex series of cylinder bore finishing steps that together provide a surface hardness and textures critical to the engine lubrication, wear and ultimately the performance and life of the liner. Standard processing will typically sequence through a rough turning operation, an induction harden and temper step followed typically by a multiple stage honing process depending on surface finish requirements. The term honing can include: standard honing, plateau honing, brush honing, fluid jet honing, laser honing, spiral slide honing, or smooth slide honing. Regardless of the method by which honing is accomplished, each step represents additional handling and processing time.

Honing operations require investment and maintenance of expensive high grade abrasive tooling and equipment along with a higher level of skilled manual labour or automation that can result in high liner manufacturing cost structures. Reducing the number of processing steps and processing time creates the opportunity for significantly reduced processing times and cost for competitive advantage.

For reference, U.S. Pat. No. 5,916,390 relates to a blank that can be formed by cold extrusion to create a shape approximating the cylinder lining. After pre-machining, the surface is fine machined, honed in at least one stage and then hard particles lying at the surface are mechanically exposed to form plateau areas of hard particles which project above the remaining surface of the base microstructure of the alloy. The mechanical exposure of the primary crystals or particles is carried out by a honing process using felt strips which are cylindrically shaped on the outside of a slurry of SiC particles in honing oil.

### SUMMARY OF THE DISCLOSURE

In one aspect of the present disclosure, a method of manufacturing a cylinder liner for an engine includes forming a semi-finished cylinder liner having an inner surface and an outer surface; rough machining the inner surface and the outer surface of the semi-finished cylinder liner; precision machining the inner surface and outer surface of the rough machined cylinder liner; and machining the inner surface of the precision machined cylinder liner by a roll skiving operation and a roll burnishing operation.

Other features and aspects of this disclosure will be apparent from the following description and the accompanying drawings.

### BRIEF DESCRIPTION OF THE DRAWINGS

FIG. 1 illustrates a partially exploded view of an exemplary engine, showing one piston and cylinder liner in section;

FIG. 2 illustrates an exemplary semi-finished cylinder liner;

FIG. 3 illustrates a method of manufacturing a finished cylinder liner for the engine shown in FIG. 1; and

FIG. 4 illustrates an exemplary roll skiving and burnishing operation performed for producing the finished cylinder liner shown in FIG. 1.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

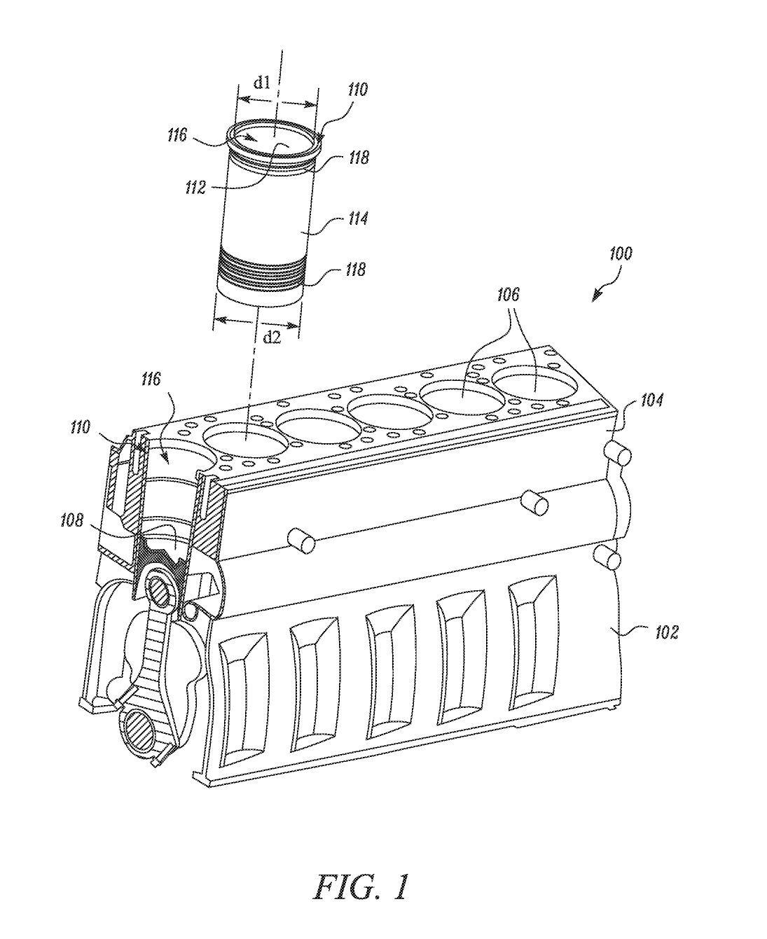

FIG. 1 illustrates a partially exploded view of an exemplary engine 100. In an embodiment, the engine 100 is a compression ignition engine that is configured to combust a closed pocket of compressed air when diesel fuel is sprayed in the closed pocket. Alternatively, the engine 100 may embody a natural gas engine, a gasoline engine, a dual fuel engine, or other reciprocating types of internal combustion engines commonly known to one having ordinary skill in the art. Moreover, the engine 100, disclosed herein, may be configured for applications such as, but not limited to, motor vehicles, work machines, locomotives, marine engines, and for use in stationary applications, such as electrical power generators.

As shown, the engine 100 includes an engine block 102 and a cylinder head 104. The engine block 102 includes a plurality of cylinder bores 106. Each of the cylinder bores 106 includes a piston 108 and a cylinder liner 110 disposed within the cylinder bore 106. Although six cylinders are positioned in an inline configuration in the illustrated embodiment of FIG. 1, it is envisioned that the present disclosure may be applicable to any number of cylinders and even other types of engine configurations, such as V-type configurations, radial configurations, and the like.

As illustrated in FIG. 1, one of the cylinder liners 110 is shown removed from the cylinder bore 106. The cylinder liner 110 includes an inner surface 112 and an outer surface 114. The inner surface 112 defines a cavity 116 within which the piston 108 reciprocates. The outer surface 114 of the cylinder liner 110 is sized and/or configured to form a cavity within the cylinder bore 106 to which coolant is circulated thereabout. Alternatively, the outer surface 114 of the cylinder liner 110 may be sized and/or configured to have a press fit in the cylinder bore 106. The inner and the outer surfaces 112, 114 may define an inner diameter d1 and an outer diameter d2 respectively.

In an embodiment as shown in FIG. 1, the cylinder liner 110 may include one or more cylindrical grooves 118 to accommodate respective sealing rings, such as O-rings (not shown). The cylindrical grooves 118 may also be configured to abut cylindrical lands (not shown) in the engine block 102 in order to provide a leak proof cavity for coolant to circulate.

For manufacturing the cylinder liners 110, a casting operation may be used. Optionally, the cylinder liners 110 may also be manufactured using cold extrusion, or powder metallurgy. Typically, the cylinder liners 110 are manufactured from iron (Fe) or steel. However, other suitable metals or alloys may also be used to manufacture the cylinder liners 110.

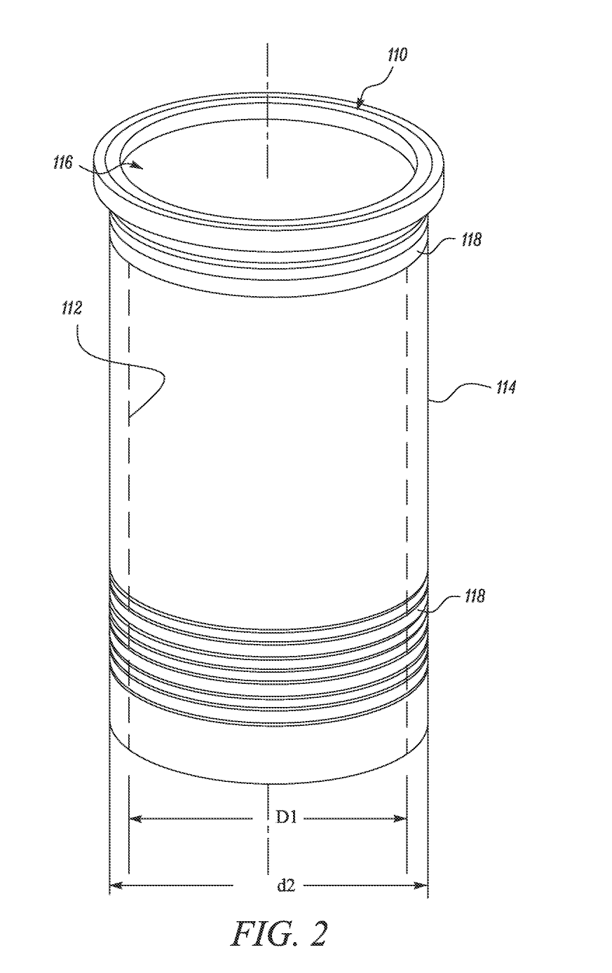

Referring to FIG. 2, a cylinder liner 120 in accordance with the present disclosure is described. The semi-finished cylinder liner 120 includes the inner surface 112 and the outer surface 114. It will be understood that the inner and the outer surfaces 112, 114 as referred herein may include defects inherent from the casting process, and their surface roughness may be higher than a required value of surface roughness, based on application and engine specification.

The cylinder liner 120 may include a rough inner diameter D1 and a final outer diameter d2, where rough inner diameter D1 is less than the inner diameter d1 of the finished cylinder liner 110 (See FIG. 1) and the final outer diameter d2 is equal to the outer diameter d2 as shown for the finished cylinder liner 110 (See FIG. 1).

The cylinder liner 120 is machined to achieve finished inner and outer surfaces 112, 114 that are of predetermined inner and outer diameters d1, d2. In addition, other operations may be performed on the cylinder liner 120 to improve the hardness, toughness and surface finish and form the cylinder liner 120 as will be explained hereinafter.

A series of surface finishing operations may be performed on the cylinder liner 120. An abrasive machining operation as part of the finish machine operations, for example, honing may be performed on the cast cylinder liner to form the cylinder liner 120. Typically, a first honing operation may be performed on the cast cylinder liner. Through the first honing operation, the surface finish of an external surface and an internal surface of the cylinder liner may be improved. Accordingly, the cylinder liner 120 disclosed herein and illustrated in FIG. 2 may be regarded as a formed cylinder liner that has undergone a rough machining operation and a precision machining operation. Therefore, the cylinder liner 120 may be construed as a precision machined cylinder liner and will hereinafter be designated by the same numeral “120”.

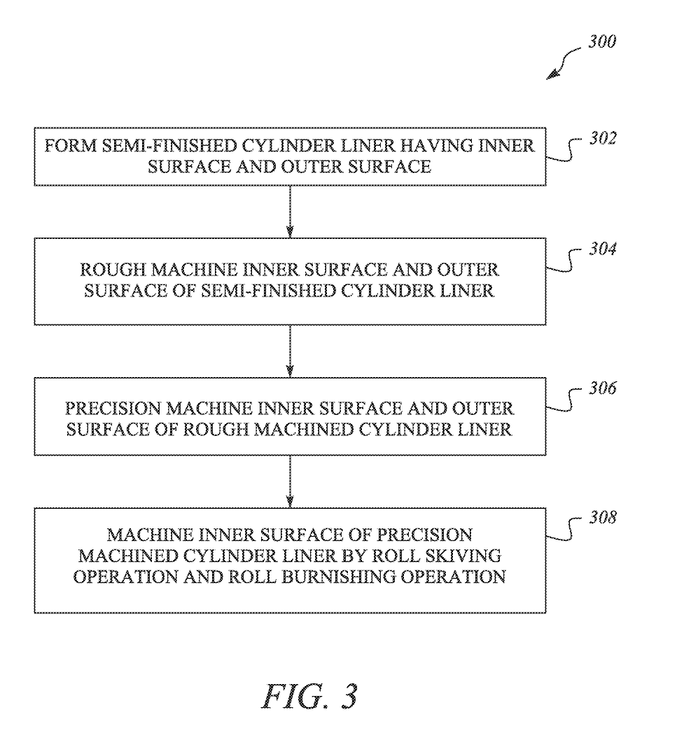

FIG. 3 illustrates a method of manufacturing the cylinder liner 110. At step 302, the method includes forming a semi-finished cylinder liner (not shown) having the inner surface and the outer surface. The semi-finished cylinder liner may be formed by casting, extrusion, powder metallurgy, and the like.

At step 304, the method further includes rough machining the inner surface and the outer surface of the semi-finished cylinder liner. In an exemplary embodiment, the inner surface of the semi-finished cylinder liner may be rough machined by performing a first honing operation of the semi-finished cylinder liner, such as, for example, an abrasive machining process. The rough machining of the cylinder liner may also result in the formation of the cylindrical grooves 118.

At step 306, the method 300 includes performing a precision machining operation on the outer surface of a rough machined cylinder liner. The precision machining of the outer surface 114 may be performed by executing a precision cutting process on the rough machined cylinder liner.

The method may include roll burnishing at least a portion of the outer surface 114 of the precision machined cylinder liner 120 (See FIG. 2). The roll burnishing of the outer surface 114 may be done by various operations that may include plastically deforming the outer surface 114 of the precision machined cylinder liner 120. However, it is to be noted that at this point, the inner surface 112 is not configured to undergo any roll burnishing and skiving as will be discussed below. The method 300 may not include a separate hardening process for the inner surface 112 of the cylinder liner 120.

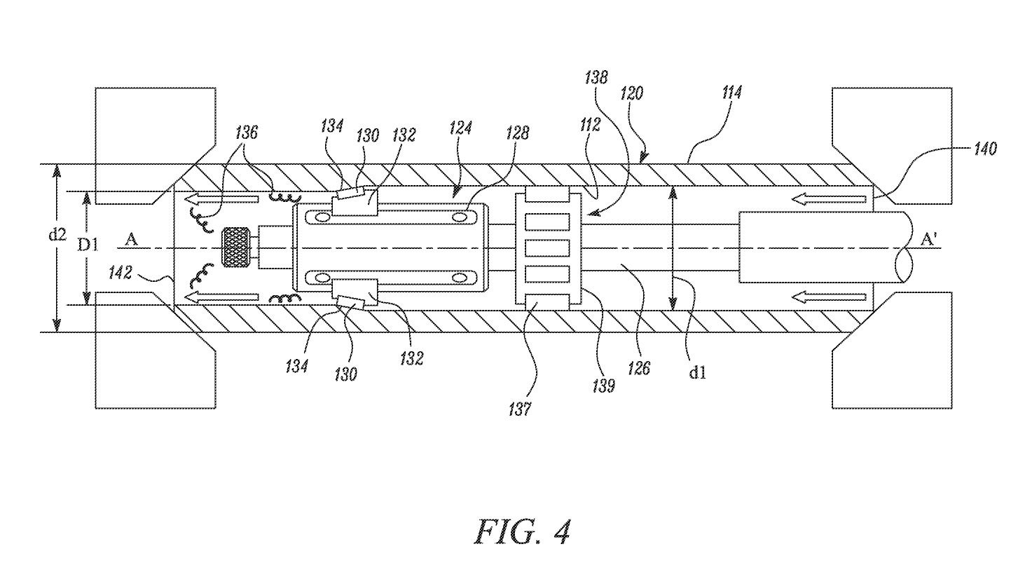

At step 310, the method further includes roll skiving the inner surface 112 of the precision machined cylinder liner 120. Explanation pertaining to the roll burnishing and roll skiving operation of the precision machined cylinder liner 120 will be made in conjunction with FIG. 4.

As shown in FIG. 4, a roll burnishing tool 138 performs a material deforming operation on the inner surface 112 of the precision machined cylinder liner 120. The roll burnishing tool 138 may include a shaft 126 having a cylindrical head 139 mounted thereon. The roll burnishing tool 138 further includes one or more of a pair of rollers 137 placed diametrically opposite on the head 139. The roll burnishing tool 138 may have a skiving head 124 attached to the shaft 126 and axially spaced from the head 138. The skiving head 124 mounted on the shaft 126 may include one or more of a pair of skiving knives 130 placed diametrically opposite on the head 124. Further, the skiving head 124 may include a plurality of wear pads 132 disposed symmetrically about the head 128 of the skiving head 124.

The wear pads 132 are configured to maintain an alignment of the skiving head 124 within the precision machined cylinder liner 120 during the roll skiving operation. Also, the wear pads 132 may be provided to beneficially absorb vibrations during rotation of the skiving head 124 within the cylinder liner 120.

In an embodiment, the shaft 126 may be hollow and define a primary coolant channel (not shown) therein. The skiving head 124 may further include one or more secondary coolant channels (not shown) in fluid communication with the primary coolant channel of the hollow shaft 126. A plurality of openings may be disposed near the pair of skiving knives 130 to allow the coolant to exit therefrom. However, in other embodiments, it may be optionally contemplated to supply the coolant externally during the roll skiving operation.

Each of the skiving knives 130 defines a cutting edge 134 that extends away from the rotational axis A-A′. Further, the skiving knives 130 may be adjustably mounted on the skiving head 124 such that a radial distance of the cutting edge 134 from the rotational axis A-A′ may be adjusted. Accordingly, suitable mechanisms for adjusting the skiving knives 130, such as a screw mechanism, a chuck mechanism and the like, may be provided on the skiving head 124.

The cutting edges 134 are configured to perform the machining operation on the inner surface 112 of the cylinder liner 120. Moreover, the coolant provided through the primary and secondary coolant channels may perform plurality of functions during the roll skiving operation. For example, the coolant may provide lubrication to the roll skiving head 124 when the roll skiving head 124 rotates against the inner surface 112. Further, the coolant may cool the skiving knives 130 and the machined areas of the inner surface 112. Moreover, the coolant may flush debris 136 accumulated due to the machining operation performed by the skiving knives 130.

In an embodiment, the roll skiving and/or burnishing operation may be performed by clamping the cylinder liner 120 and rotating the roll skiving and/or burnishing tool 138 within the cylinder liner 120. The skiving knives 130 may be adjusted such that the cutting edge 134 may machine the rough inner diameter D1 to the specified or predetermined inner diameter smaller than d1 to allow for material deformation by the roll burnishing tool to form the desired inner diameter d1. When the cylinder liner 120 is clamped, the roll skiving and/or burnishing tool 124 may be inserted from one end 140 of the cylinder liner 120. The roll skiving and/or burnishing tool 124 rotates within the cylinder liner 120 such that the cutting edge 134 of the skiving knives 130 contacts the inner surface 112 and machines the inner surface 112 of the cylinder liner 120.

At this point, the coolant supply may be switched on to provide lubrication to the roll skiving and/or burnishing tool 124, cooling to the skiving knives 130, burnishing rollers 137 and the inner surface 112, and flushing off the machined metal debris 136 from other end 142 of the cylinder liner 122. When the roll skiving and/or burnishing tool 124 exits from the other end 142 of the cylinder liner, the rough inner diameter D1 of the cylinder liner 120 is machined to the predetermined inner diameter d1.

Hereafter, the cylinder liner 120 may now be referred to as “the cylinder liner 110” barring a washing step mentioned below. As such, the step of washing is an optional step for purposes of the present disclosure as it may be carried out to flush out any metal debris or surface contaminants. Hence, after the roll skiving and/or burnishing operation, the inner and the outer surface 112, 114 of the cylinder liner 110 may be optionally washed using a suitable chemical solution to flush out any metal debris or surface contaminants. Further, the cylinder liner 110 may then be inspected for any surface deformities with the use of methods such as, but not limited to, eddy current inspection or other methods commonly known to one skilled in the art.

The cylinder liner 110 may now be considered ready for fitment onto a cylinder of the engine 100.

### INDUSTRIAL APPLICABILITY

With use of the method 300 disclosed herein, numerous steps previously required to be performed on cylinder liners, for e.g., a work hardening process is now achieved by way of the roll burnishing process. When the roll burnishing tool 124 deforms the inner surface 112 of the cylinder liner 120, the inner surface 112 undergoes localized hardening due to a cold working of the material forming the cylinder liner 120. This material deformation improves the surface finish of the cylinder liner 120. Further, the roll skiving and/or burnishing process as disclosed herein eliminates the use of successive and/or repeated honing and machining operations that were typically performed on inner surfaces of cylinder liners. Thus, with implementation of the method 300 disclosed herein, specific tooling, machinery and/or labour previously required for accomplishing honing and other surface finishing operations are now mitigated. Moreover, with use of the method 300 disclosed herein, costs associated with manufacturing of cylinder liners may be reduced. Further, as the method 300 described herein involves less steps and processes, costs and cycle times associated with the manufacture of cylinder liners is reduced.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of manufacturing a cylinder liner for an engine, the method comprising:
forming a semi-finished cylinder liner having an inner surface and an outer surface;
rough machining the inner surface and the outer surface of the semi-finished cylinder liner;
precision machining the inner surface and outer surface of the rough machined cylinder liner; and
machining the inner surface of the precision machined cylinder liner by a roll skiving operation and a roll burnishing operation.
